(19) United States
(12) Patent Application Publication
(10) Pub. No.: US 2026/0302006 A1
(43) Pub. Date: Oct. 1, 2026

(54) LOW-COST ELECTRODE FOR METAL OXIDE VARISTORS

(71) Applicant: Dongguan Littelfuse Electronics Company Limited, Dongguan City (CN)

(72) Inventors: Ping He, Dongguan City (CN); Ganyang Shen, Dongguan City (CN); Kang Zhou, Dongguan City (CN); Jibin Lv, Dongguan City (CN)

(73) Assignee: Dongguan Littelfuse Electronics Company Limited, Dongguan City (CN)

(21) Appl. No.: 19/632,880

(22) Filed: Mar. 30, 2026

(30) Foreign Application Priority Data
Mar. 31, 2025 (CN) 202510398458.5

(51) Int. Cl. H01C 7/102; H01C 1/142; H01C 7/108; H01C 17/12

(52) U.S. Cl. CPC H01C 7/102; H01C 1/142; H01C 7/108; H01C 17/12

(57) ABSTRACT

A metal oxide varistor including a metal oxide varistor chip, a first electrode disposed on a first side of the metal oxide varistor chip and a second electrode disposed on a second side of the metal oxide varistor chip, wherein each of the first electrode and the second electrode includes a seed layer formed of a nickel alloy disposed directly on a surface of the metal oxide varistor chip, and a cover layer formed of metal disposed on the seed layer.

### BACKGROUND

### CROSS-REFERENCE TO RELATED APPLICATIONS

This application claims the benefit of priority to, Chinese Patent Application No. 202510398458.5, filed Mar. 31, 2025, entitled “LOW-COST ELECTRODE FOR METAL OXIDE VARISTORS,” which application is incorporated herein by reference in its entirety.

### Field

The present disclosure relates generally to the field of circuit protection devices. More specifically, the present disclosure relates to low-cost electrodes for metal oxide varistors.

### Description of Related Art

Metal oxide varistors (MOVs) are voltage dependent, nonlinear devices that provide transient voltage suppression in electronic circuits. A MOV has high electrical resistance when subjected to a low voltage and a low electrical resistance when subjected to a high voltage. When connected in parallel with a protected circuit component, a MOV can clamp voltage to a safe level in the event of a high transient voltage in the circuit. The MOV thus absorbs energy that could otherwise damage the protected component.

Most basically, a MOV includes a MOV chip formed of a material having the voltage dependent, nonlinear resistance characteristics described above. A MOV chip is typically formed of a ceramic material (e.g., zinc oxide) with small additions of other metal oxides like bismuth, cobalt, and manganese. Metal electrodes are applied to opposite sides of the MOV chip (e.g., via printing, sputter deposition, etc.) to facilitate electrical connection of the MOV within a circuit, such as via conductive leads soldered to the electrodes.

Commonly, MOV electrodes are formed of precious metals, such as silver. Such metals have surface energies that are similar to those of ceramics used in MOV chips, allowing the metals adhere to the surfaces of MOV chips in continuous, planar layers having desired thicknesses. However, the increasing cost of precious metals has led to a need for alternative materials that can achieve similar or better performance at a lower cost. Copper would be a good candidate for such a material, but the surface energy of copper is significantly different than the surface energies of ceramics used in MOV chips. This disparity in surface energy results in poor wettability between the surfaces of a MOV chip and copper. Thus, when molten copper is applied to a MOV chip, the copper atoms lack sufficient surface tension to effectively spread and conform to the ceramic surface, leading to the formation of isolated islands of copper rather than a continuous, well-adhered layer.

It is with respect to these and other considerations that the present improvements may be useful.

### SUMMARY

This Summary is provided to introduce a selection of concepts in a simplified form further described below in the Detailed Description. This Summary is not intended to identify key features or essential features of the claimed subject matter, nor is the summary intended as an aid in determining the scope of the claimed subject matter.

A metal oxide varistor according to an embodiment of the present disclosure includes a metal oxide varistor chip, a first electrode disposed on a first side of the metal oxide varistor chip and a second electrode disposed on a second side of the metal oxide varistor chip, wherein each of the first electrode and the second electrode includes a seed layer formed of a nickel alloy disposed directly on a surface of the metal oxide varistor chip, and a cover layer formed of metal disposed on the seed layer.

A metal oxide varistor according to an embodiment of the present disclosure includes a metal oxide varistor chip, a first electrode disposed on a first side of the metal oxide varistor chip and a second electrode disposed on a second side of the metal oxide varistor chip, wherein each of the first electrode and the second electrode includes a seed layer formed of a nickel alloy disposed directly on a surface of the metal oxide varistor chip, and a cover layer formed of metal disposed on the seed layer.

A method of manufacturing a metal oxide varistor according to an embodiment of the present disclosure includes providing a metal oxide varistor chip, forming an electrode on a surface of the metal oxide varistor chip, including, applying a seed layer formed of a nickel alloy to a surface of the metal oxide varistor chip, and applying a cover layer formed of metal on the seed layer.

### BRIEF DESCRIPTION OF THE DRAWINGS

The accompanying drawings illustrate exemplary approaches of the present disclosure, including the practical application of the principles thereof, as follows:

FIG. 1 is a side view illustrating a metal oxide varistor in accordance with the present disclosure;

FIG. 2 a cross-sectional view illustrating the metal oxide varistor shown in FIG. 1;

FIGS. 3 is a flow diagram illustrating a method of manufacturing the metal oxide varistor shown in FIGS. 1 and 2.

### DETAILED DESCRIPTION

An embodiment of a metal oxide varistor (MOV) and an associated method of manufacture in accordance with the present disclosure will now be described more fully hereinafter with reference to the accompanying drawings. The MOV and the associated method may, however, be embodied in many different forms and should not be construed as being limited to the embodiments set forth herein. Rather, these embodiments are provided so that this disclosure will convey certain exemplary aspects of the MOV and the associated method to those of ordinary skill in the art.

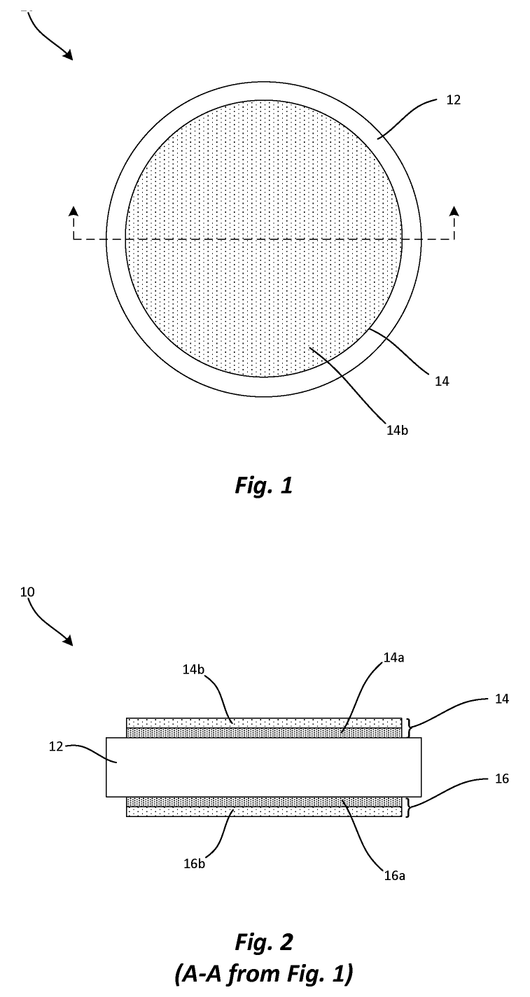

Referring to FIGS. 1 and 2, a side view and a cross-sectional view illustrating a metal oxide varistor 10 (hereinafter “the MOV 10”) in accordance with an embodiment of the present disclosure are shown, respectively. The MOV 10 may include a MOV chip 12 having electrically conductive first and second electrodes 14, 16 disposed on opposing first and second sides thereof. The MOV chip 12 may be formed of any MOV composition known in the art, such as a ceramic material (e.g., zinc oxide) mixed with a quantity of one or more other metal oxides (e.g., bismuth, cobalt, and manganese, etc.). The present disclosure is not limited in this regard. The MOV chip 12 and the first and second electrodes 14, 16 are depicted as being circular in shape, but this is not critical. It is contemplated that one or more of the MOV chip 12 and the first and second electrodes 14, 16 may have a different shape, such as rectangular, triangular, irregular, etc. without departing from the scope of the present disclosure.

The first and second electrodes 14, 16 may each include a seed layer 14a, 16a and a cover layer 14b, 16b disposed in a stacked arrangement in the aforementioned order. The seed layers 14a, 16a may be formed of a nickel alloy (e.g., iron-nickel alloy) and may be disposed directly on the opposing surfaces of the MOV chip 12. In various embodiments, the seed layers 14a,16a may be applied to the MOV chip 12 using a sputtering process (e.g., magnetron sputtering) and may each have a thickness in a range of 0.01 microns to 2.00 microns. The present disclosure is not limited in this regard. Nickel exhibits excellent wetting properties when applied to ceramic, ensuring strong adhesion of the seed layers 14a, 16a to the MOV chip 12. Additionally, nickel has a coefficient thermal expansion that is similar to that of the ceramic material of the MOV chip 12, thus reducing the risk of delamination of the seed layers 14a, 16a due to thermal stress during operation of the MOV 10.

The cover layers 14b, 16b may be disposed on the respective seed layers 14a, 16a and may be formed of a metal different than the seed layers 14a, 16a. In various embodiments, the cover layers 14b, 16b may be formed of a non-precious metal (e.g., copper, tin, aluminum, etc.) and may each have a thickness in a range of 0.05 microns to 20.00 microns. The present disclosure is not limited in this regard. Copper, in particular, possesses exceptional thermal and electrical conductivity, ensuring good electrical performance of the MOV 10 when connected in a circuit. Thus, the cover layers 14b, 16b may effectively transmit high currents and dissipate heat efficiently, contributing to the overall stability and reliability of the MOV 10.

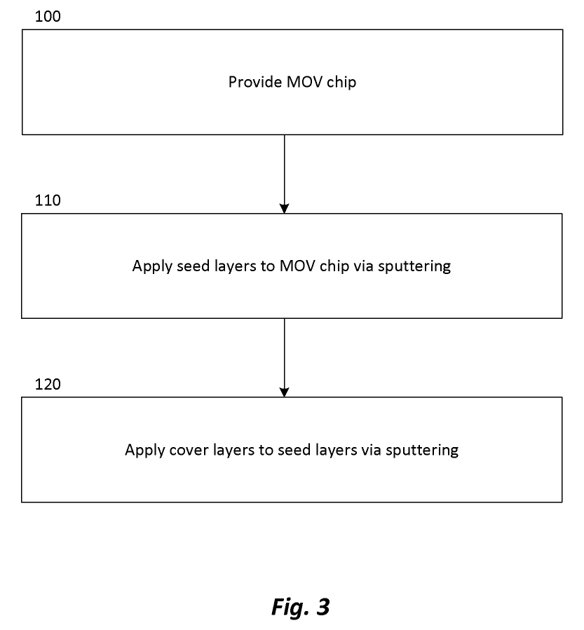

Referring to FIG. 3, a flow diagram illustrating a method of manufacturing the above described MOV 10 is shown. The method will be described with reference to the MOV 10 as shown in FIGS. 1 and 2.

In block 100 of the method shown in FIG. 3, the MOV chip 12 may be provided. The MOV chip may be formed of any MOV composition known in the art, such as a ceramic material (e.g., zinc oxide) mixed with a quantity of one or more other metal oxides (bismuth, cobalt, and manganese, etc.). The present disclosure is not limited in this regard. The MOV chip 12 is depicted as being circular in shape, but this is not critical. It is contemplated that the MOV chip 12 may have a different shape, such as rectangular, triangular, irregular, etc. without departing from the scope of the present disclosure.

In block 110 of the method shown in FIG. 3, the MOV chip 12 may be provided. The MOV chip 12 may be formed of any MOV composition known in the art, such as a ceramic material (e.g., zinc oxide) mixed with a quantity of one or more other metal oxides (e.g., bismuth, cobalt, and manganese, etc.). The present disclosure is not limited in this regard. The MOV chip 12 is depicted as being circular in shape, but this is not critical. It is contemplated that the MOV chip 12 may have a different shape, such as rectangular, triangular, irregular, etc. without departing from the scope of the present disclosure.

In block 110 of the method shown in FIG. 3, the seed layers 14a, 16a may be applied directly to opposing surfaces of the MOV chip 12. The seed layers 14a, 16a may be formed of a nickel alloy (e.g., iron-nickel alloy) and may be applied to the MOV chip 12 using a sputtering process (e.g., a magnetron sputtering process). Each of the seed layers 14a, 16a may each have a thickness in a range of 0.01 microns to 2.00 microns. The present disclosure is not limited in this regard. As described above, nickel exhibits excellent wetting properties when applied to ceramic, ensuring strong adhesion of the seed layers 14a, 16a to the MOV chip 12. Additionally, the sputtering process used to apply the seed layers 14a, 16a allows for precise control over the deposition thickness and uniformity of the seed layers 14a, 16a.

In block 120 of the method shown in FIG. 3, the cover layers 14b, 16b may be applied to the respective seed layers 14a,16a. The cover layers 14b, 16b may be formed of a metal different than the seed layers 14a, 16a and may be applied to the seed layers 14a, 16a using a sputtering process (e.g., a magnetron sputtering process). In various embodiments, the cover layers 14b, 16b may be formed a non-precious metal (e.g., copper, tin, aluminum, etc.) and may each have a thickness in a range of 0.05 microns to 20.00 microns. The present disclosure is not limited in this regard. As described above, copper, in particular, possesses exceptional thermal and electrical conductivity, ensuring good electrical performance of the MOV 10 when connected in a circuit. Thus, the cover layers 14b, 16b may effectively transmit high currents and dissipate heat efficiently, contributing to the overall stability and reliability of the MOV 10.

When the first and second 14, 16 electrodes are formed on the MOV chip 12 in the manner described above with respect to blocks 110 and 120 of the method, each of the seed layers 14a, 16a acts as a transition layer, seamlessly binding the copper cover layers 14b, 16b to the ceramic MOV chip 12. Moreover, the seed layers 14a, 16a act as barriers that prevent the copper cover layers 14b, 16b from diffusing to the ceramic material of the MOV chip 12.

Those of skill in the art will appreciate the numerous advantages provided by the embodiments of the present disclosure. Namely, the above-described embodiments provide MOV electrodes that offer robust, reliable performance and that can be manufactured at a much lower cost relative to traditional electrodes formed of precious metals.

As used herein, an element or step recited in the singular and proceeded with the word "a" or "an" should be understood as not excluding plural elements or steps, unless such exclusion is explicitly recited. Furthermore, references to "one embodiment" of the present disclosure are not intended to be interpreted as excluding the existence of additional embodiments that also incorporate the recited features.

While the present disclosure makes reference to certain embodiments, numerous modifications, alterations and changes to the described embodiments are possible without

departing from the sphere and scope of the present disclosure, as defined in the appended claim(s). Accordingly, it is intended that the present disclosure not be limited to the described embodiments, but that it has the full scope defined by the language of the following claims, and equivalents thereof.

1. A metal oxide varistor comprising:
a metal oxide varistor chip;
a first electrode disposed on a first side of the metal oxide varistor chip and a second electrode disposed on a second side of the metal oxide varistor chip, wherein each of the first electrode and the second electrode comprises:
a seed layer formed of a nickel alloy disposed directly on a surface of the metal oxide varistor chip; and
a cover layer formed of metal disposed on the seed layer.

2. The metal oxide varistor of claim 1, wherein the seed layer is formed of iron-nickel alloy.

3. The metal oxide varistor of claim 1, wherein the cover layer is formed of a non-precious metal.

4. The metal oxide varistor of claim 3, wherein the cover layer is formed of one of copper, tin, and aluminum.

5. The metal oxide varistor of claim 1, wherein the seed layer has a thickness in a range of 0.01 microns to 2.00 microns.

6. The metal oxide varistor of claim 1, wherein the cover layer has a thickness in a range of 0.05 microns to 20.00 microns.

7. A method of manufacturing a metal oxide varistor comprising:
providing a metal oxide varistor chip;
forming an electrode on a surface of the metal oxide varistor chip, including:
applying a seed layer formed of a nickel alloy to the surface of the metal oxide varistor chip; and
applying a cover layer formed of metal on the seed layer.

8. The method of claim 7, wherein the seed layer is formed of iron-nickel alloy.

9. The method of claim 7, wherein the cover layer is formed of a non-precious metal.

10. The method of claim 9, wherein the cover layer is formed of one of copper, tin, and aluminum.

11. The method of claim 7, wherein the seed layer has a thickness in a range of 0.01 microns to 2.00 microns.

12. The method of claim 7, wherein the cover layer has a thickness in a range of 0.05 microns to 20.00 microns.

13. The method of claim 7, wherein at least one of the seed layer and the cover layer is applied using a sputtering process.
